(19) United States
(12) Patent Application Publication
(10) Pub. No.: US 2024/0371037 A1
(43) Pub. Date: Nov. 7, 2024

(54) CALIBRATION OF 3D SCANNING SYSTEMS

(71) Applicant: Hewlett-Packard Development Company, L.P., Spring, TX (US)

(72) Inventor: Markus Ernst RILK, Braunschweig (DE)

(21) Appl. No.: 18/572,933

(22) PCT Filed: Jun. 29, 2021
(86) PCT No.: PCT/US2021/039700

§ 371 Date: Dec. 21, 2023

(51) Int. Cl. G06T 7/80

(52) U.S. Cl. CPC G06T 7/80; G06T 2207/30204

(57) ABSTRACT

A method is described in which a calibration target having a plurality of spheres is placed in a scan volume of a 3D scanning system. Images of the calibration target are captured using the 3D scanning system. Image pixel correspondences of the captured images are determined, and the 3D scanning system is calibrated using the image pixel correspondences.

### BACKGROUND

A 3D scanning system may be calibrated to correct for tolerances in the system. The system may comprise camera models describing cameras of the system, and parameters of the camera models may be refined to calibrate the system.

### BRIEF DESCRIPTION OF THE DRAWINGS

FIG. 1 shows an example method for calibrating a 3D scanning system;

FIG. 2 shows an example calibration target;

FIG. 3 shows an example method for calibrating camera models of the 3D scanning system;

FIG. 4 shows a further example method for calibrating a 3D scanning system;

FIG. 5 shows a further example method for calibrating camera models of the 3D scanning system; and

FIG. 6 shows a block diagram of a computing device.

### DETAILED DESCRIPTION

In some 3D scanning systems, an object may be scanned by illuminating the object with a light source and capturing images of the illuminated object using cameras. For example, in a structured light scanning system, the light source may comprise a projector that projects a pattern of light onto the object. In a laser scanning system, the light source may comprise a laser that projects a dot or line that is swept across the object. The 3D scanning system then reconstructs the geometry of the object from image data captured by the cameras.

A 3D scanning system may be calibrated to correct for tolerances in the system. In one example, the system may comprise camera models that describe the cameras of the system, and calibration may involve determining or refining parameters of the camera models. Suitable camera models include, for example, MATLAB and OpenCV models. Parameters of the camera models may include extrinsic parameters (e.g. translation and rotation), intrinsic parameters (e.g. focal length, principal point, skew coefficient), and/or lens distortion (e.g. coefficients of radial and tangential distortion).

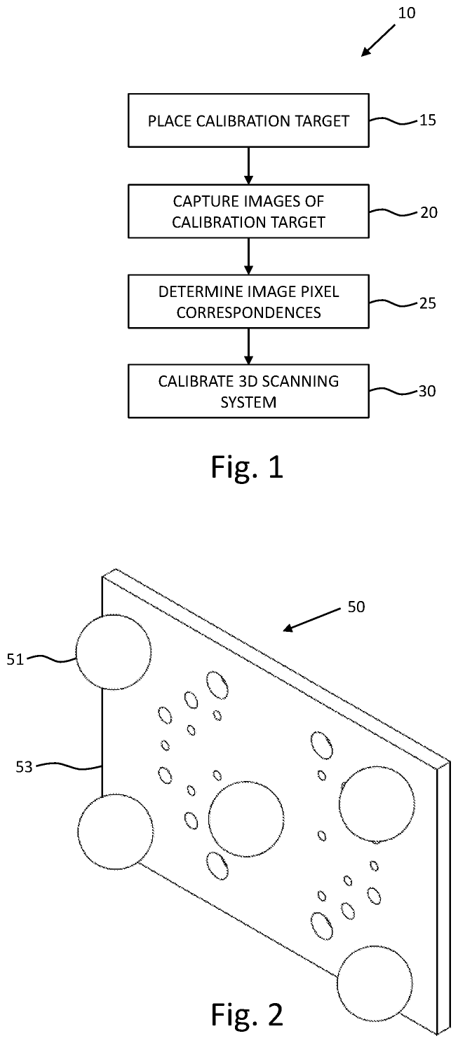

FIG. 1 shows an example method 10 for calibrating a 3D scanning system.

The method 10 comprises placing 15 a calibration target 50 having a plurality of spheres 51 in a scan volume of a 3D scanning system. FIG. 2 shows an example calibration target 50 comprising a plurality of spheres 51 mounted on a plate 53. The provision of a plate 53 may aid handling of the target 50 during calibration, but any 3D object comprising a plurality of spheres may be used as a calibration target. For example, the calibration target may comprise spheres interconnected by rods.

In the particular example of calibration target 50 shown in FIG. 2, the target 50 comprises five spheres 51 having a symmetrical arrangement. Arranging the spheres 51 symmetrically may aid the identification of faults during calibration. For example, a symmetrical arrangement of spheres should produce a symmetrical distribution of difference errors; that is to say that the differences between estimated properties of the spheres (e.g. sizes or positions) and the actual, known properties of the spheres should be the same upon rotating the calibration target through an angle of rotational symmetry. Asymmetry in the difference errors may therefore be an indicator of a fault during calibration, such as the calibration target being moved inadvertently during image capture. A calibration target having an alternative number and arrangement of spheres may nevertheless be used.

In the illustrated example, the spheres 51 of the calibration target 50 each have a diameter of around 25 mm. In other examples, the spheres 51 may have an alternative size. Furthermore, the calibration target 50 may comprise spheres 51 of different sizes. As the sizes of the spheres 51 decrease, optical smoothing of the 3D scanning system may adversely impact the accuracy of the calibration. As the sizes of the spheres increases, handling of the calibration target 50 may be more difficult. Additionally, manufacturing spheres of high dimensional accuracy (e.g. roundness, surface smoothness) may be more difficult for larger spheres. Accordingly, in some examples, the spheres 51 of the calibration target 50 may have a diameter of between 10 mm and 100 mm.

The spheres 51 of FIG. 2 may be manufactured, for example, from metal. As a result, a high dimensional accuracy may be achieved for the shape and size of the spheres, which in turn aids the accuracy of the calibration. However, metals generally have a high surface reflectivity, which may introduce noise into the calibration due to the scattering of light by the reflective surfaces of the spheres 51. To reduce this scattering, surfaces of the spheres 51 may be matte or dull. This may be achieved, for example, by surface treatment or through the use of a metal that is intrinsically dull. An example of a metal having a relatively low reflectivity is titanium. The spheres 51 may alternatively be manufactured from an alternative material, such as a polymeric or ceramic material.

In the example calibration target 50 shown in FIG. 2, all of the spheres 51 lie in a common plane. In an alternative example, the calibration target 50 may comprise at least one sphere 51 that lies outside the common plane. For example, the calibration target 50 may comprise at least three spheres 51 that lie in a common plane, and at least a fourth sphere 51 that lies outside the common plane. This may aid the robustness of the calibration by providing a calibration input in a direction perpendicular to the plane.

The method 10 further comprises capturing 20 images of the calibration target 50 using the 3D scanning system. The images are captured 20 by illuminating the calibration target 50 with light from a light source, and capturing the reflected light with cameras of the 3D scanning system. The resulting image data output by each of the cameras comprises a 2D image of a view of the spheres 51 in the scan volume. The image data output by each camera may comprise a single image of the spheres 51. Alternatively, the image data may comprise a plurality of images, each image captured by a respective camera and corresponding to a different position or orientation of the calibration target 50. As a result, a more robust and/or more accurate calibration may be achieved. For example, by using a higher number of images in the calibration, underdetermination or poor determination of the parameters being calibrated may be avoided. Additionally or alternatively, where mathematical optimization is used in the calibration, the provision of a higher number of images may help avoid local minima.

The method then comprises determining 25 image pixel correspondences of the captured images. Each image pixel correspondence comprises a set of pixels, one pixel per image captured by each camera, that correspond to the same surface point of the calibration target 50.

The method comprises calibrating 30 the 3D scanning system using the image pixel correspondences. Calibrating 30 the 3D scanning system may comprises determining or refining parameters of the camera models employed by the system. As noted above, the parameters of the camera models may include, for example, extrinsic parameters (e.g. translation and rotation), intrinsic parameters (e.g. focal length, principal point, skew coefficient), and/or lens distortion (e.g. coefficients of radial and tangential distortion). In one example, mathematical optimization may be used to determine or refine the parameters of the camera models.

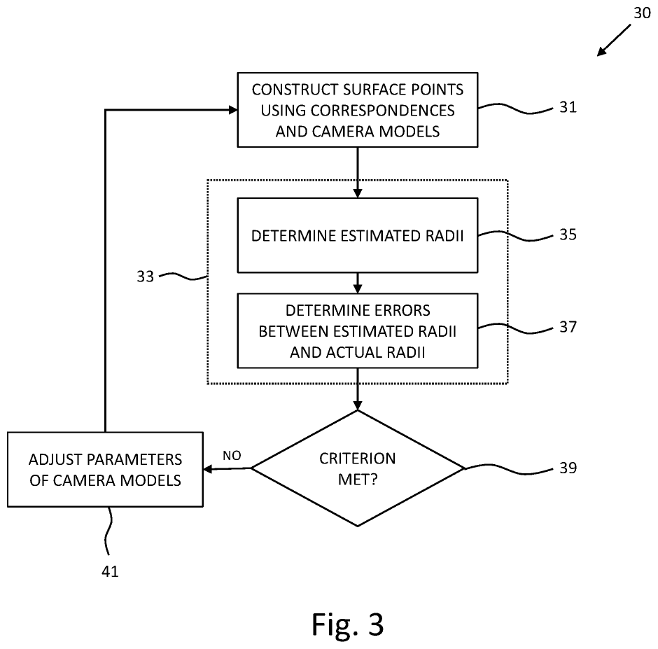

FIG. 3 shows an example method for determining or refining the parameters of the camera models. The method 30 comprises constructing 31 surface points of the spheres using the image pixel correspondences and the camera models. The method 30 further comprises solving 33 an error function based on the constructed surface points and determining 39 whether the error function meets or satisfies a criterion. In the event that the criterion is met, the parameters of the camera models are deemed calibrated. In the event that the criterion is not met, the parameters of the camera models are adjusted 41 and the method 30 is repeated.

In the example shown in FIG. 3, solving 33 the error function comprises determining 35 estimated radii based on the surface points, and determining 37 difference errors between the estimated radii and the actual radii of the spheres 51. Each of the estimated radii corresponds to the distance between an estimated center point of a sphere 51 and a constructed surface point for that sphere 51. The estimated center point of a sphere 51 may be determined initially by performing, for example, a least squares fit of the constructed surface points for that sphere 51. Thereafter, the estimated center point may be adjusted, along with parameters of the camera models in the event that the criterion is not met. In some examples, the least squares fit may comprise fitting a reference sphere to the constructed surface points. The center point and the radius of the reference sphere are then adjusted so as to minimize the sum of the squares of the differences between the constructed surface points and the corresponding surface points of the reference sphere. In other examples, the least squares fit may be constrained by fixing the radius of the reference sphere to the actual, known radius of the sphere.

Each of the spheres 51 has a radius of known value. Accordingly, the actual radii of the spheres 51 is known. Each difference error then corresponds to the difference between an estimated radius of a surface point of a sphere 51 and the actual radius of the sphere 51. The error function may then correspond to the sum of the difference errors.

The method may determine 39 that the criterion is met when a minimum in the error function has been identified, or when the error function is less than a threshold.

By using a calibration target 50 comprising a plurality of the spheres 51 to calibrate the 3D scanning system, a more robust and/or accurate calibration may be achieved. In particular, each sphere 51 has a circular perimeter within the captured images irrespective of the angle or orientation of the calibration target 50 relative to the cameras. As a result, the geometry of the spheres 51 may be determined with relatively good accuracy. By contrast, the markers on a two-dimensional calibration target, such as dots or rings, may appear distorted in the captured images depending on the angle or orientation of the calibration target relative to the cameras. This distortion can then introduce a greater error in the estimated geometry of the calibration target.

Some examples use, within a 3D scanning system, targets having spheres. However, such targets are used to verify the accuracy of the calibrated system. The target is not used to calibrate the system. In particular, the target is not used to determine or refine parameters of a camera model.

In the above method 10, the parameters of the camera models may have initial values that are refined by the method 10. For example, the initial values may have been defined during a calibration process performed by the manufacturer of the 3D scanning system. However, it may be desirable for a user to refine these initial values, for example, to compensate for the ambient temperature or to correct for changes to the system that may have occurred during transit (e.g. impacts to the system).

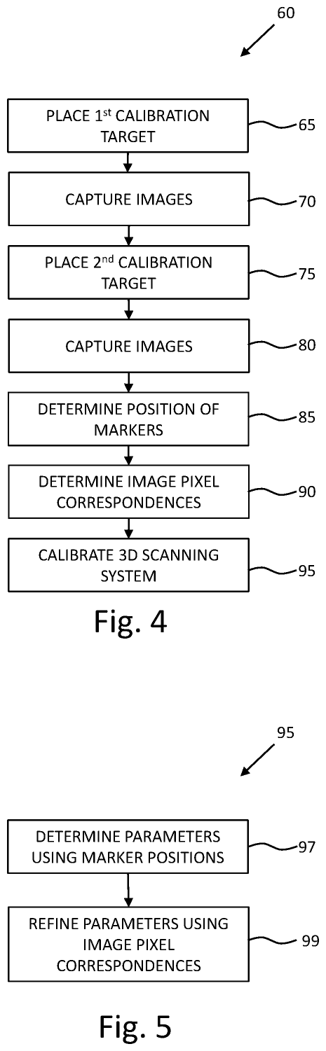

FIG. 4 illustrates a further example method 60 for calibrating a 3D scanning system. The method 60 comprises placing 65 a first calibration target in a scan volume of a 3D scanning system, and capturing 70 images of the first calibration target using the 3D scanning system. The first calibration target comprises a plurality of two-dimensional markers. In one example, the first calibration target comprises a flat plate having a pattern of dots.

The method 60 further comprises placing 75 a second calibration target 50 in the scan volume of the 3D scanning system, and capturing 80 images of the second calibration target using the 3D scanning system. The second calibration target comprises a plurality of spheres, such as the example target 50 shown in FIG. 2.

The method 60 comprises determining 85 the center positions of the markers in the captured images, and determining 90 image pixel correspondences of the spheres in the captured images. The determined positions and image pixel correspondences are then used to calibrate 95 the 3D scanning system.

In one example, shown in FIG. 5, calibrating 95 the 3D scanning system comprises determining 97 parameters of the camera models of the 3D scanning system using the determined positions of the markers, and subsequently refining 99 the parameters using the determined image pixel correspondences. Refining 99 the parameters may comprise adjusting the parameters within constraints. In one example, the constraints may comprise value ranges placed around the parameters of the camera models that were determined using the marker locations. Mathematical optimization may then be used to refine the parameters using the error function described above.

In another example, calibrating 95 the 3D scanning system may comprise determining or refining parameters of the camera models using the marker positions and image pixel correspondences simultaneously. That is to say that the parameters of the camera models may be determined or refined using both the marker positions and the image pixel correspondences in a single operation, rather than using the marker positions to initially determine the parameters and then using the image pixel correspondences to subsequently refine the parameters.

By determining the parameters of the camera models using both a first calibration target having two-dimensional markers, and a second calibration target having three-dimensional spheres, a more robust and accurate calibration of the 3D scanning system may be achieved. For example, underdetermination or poor determination of the parameters of the camera models may be avoided. Moreover, where mathematical optimization is used in the calibration, the provision of a greater number of inputs may help avoid local minima.

Although the method 60 described above refers to the use of separate first and second calibration targets, conceivably a single calibration target comprising both the two-dimensional markers and the three-dimensional spheres may be used. The markers and spheres may be provided on the same side of the calibration target. Alternatively, the calibration target may comprise a plate having markers on one side, and spheres on an opposite side.

The example methods described above may be implemented by a computing device.

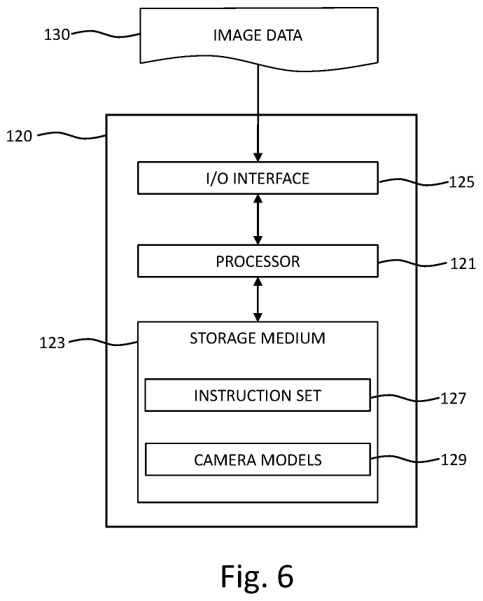

FIG. 6 illustrates an example computing device 120. The computing device comprises a processor 121, a non-transitory storage medium 123, and an input/output interface 125. The processor 121 is responsible for controlling the operation of the computing device 120 and executes an instruction set 127 stored in the storage medium 123. When executed by the processor 121, the instruction set 127 causes the computing device 120 to receive at the interface 125 image data 130 of a calibration target 50 having a plurality of spheres 51 in a scan volume. In one example, the image data 130 may be from cameras of a 3D scanning system.

The instruction set 127 additionally causes the computing device 120 to determine image pixel correspondences from the image data 130.

The instruction set 127 then causes the computing device 120 to refine parameters of camera models 129 using the determined image pixel correspondences.

The instruction set 127 may additionally cause the computing device 120 to receiving at the interface 125 further image data of a calibration target having a plurality of two-dimensional markers in the scan volume, determine from the further image data positions of the markers, and determine parameters of the camera models 129 using the determined positions of the markers. The further image data may be from the cameras.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method comprising:
placing a calibration target having a plurality of spheres in a scan volume of a 3D scanning system;
capturing images of the calibration target using the 3D scanning system;
determining image pixel correspondences of the captured images; and
calibrating the 3D scanning system using the image pixel correspondences.

2. A method as claimed in claim 1, wherein calibrating the 3D scanning system using the image pixel correspondences comprises:
constructing surface points of the spheres using the image pixel correspondences and camera models;
solving an error function based on the constructed surface points; and
adjusting parameters of the camera models to reduce the error function.

3. A method as claimed in claim 2, wherein each sphere has a known radius, and solving the error function comprises determining, for surface points of each sphere, a difference error between the estimated radius at a surface point and the known radius.

4. A method as claimed in claim 1, wherein the method comprises:
placing a further calibration target having a plurality of two-dimensional markers in the scan volume;
capturing images of the further calibration target using the 3D scanning system;
determining positions of the markers in the captured images; and
calibrating the 3D scanning system using the determined positions of the markers.

5. A method as claimed in claim 4, wherein calibrating the 3D scanning system comprises:
determining parameters of camera models using the determined positions of the markers; and
refining the parameters using the determined image pixel correspondences.

6. A method as claimed in claim 5, wherein refining the parameters comprises adjusting the parameters within constraints.

7. A method as claimed in claim 1, wherein the calibration target comprises at least three spheres.

8. A method as claimed in claim 1, wherein the calibration target comprises at least four spheres, three of the spheres lie in a common plane, and at least a fourth sphere lies outside the common plane.

9. A method comprising:
receiving image data from cameras of a 3D scanning system, the image data comprising views of a calibration target having a plurality of spheres in a scan volume;
determining from the image data image pixel correspondences; and
refining parameters of camera models of the 3D scanning system using the determined image pixel correspondences.

10. A method as claimed in claim 9, wherein refining the parameters comprises:
constructing surface points of the spheres using the image pixel correspondences and the camera models;
solving an error function based on the constructed surface points; and
adjusting parameters of the camera models to reduce the error function.

11. A method as claimed in claim 10, wherein each sphere has a known radius, and solving the error function comprises determining, for surface points of each sphere, a difference error between the estimated radius at a surface point and the known radius.

12. A method as claimed in claim 9, wherein the method comprises:
receiving further image data from the cameras, the further image data comprising views of a further calibration target having a plurality of two-dimensional markers in the scan volume;
determining from the further image data positions of the markers;
determining parameters of the camera models using the determined positions of the markers; and
refining the parameters using the determined image pixel correspondences.

13. A method as claimed in claim 10, wherein refining the parameters comprises adjusting the parameters within constraints.

14. A method as claimed in claim 9, wherein the calibration target comprises at least three spheres.

15. A non-transitory storage medium storing machine-readable instructions that, when executed by a processor of a computing device, cause the computing device to:
receive image data of a calibration target having a plurality of spheres in a scan volume;
determine from the image data image pixel correspondences; and
refine parameters of camera models using the determined image pixel correspondences.
